(19) United States
(12) Patent Application Publication
(10) Pub. No.: US 2025/0391209 A1
(43) Pub. Date: Dec. 25, 2025

(54) Method for an autonomously driving vehicle for storing environmental detection data in a permanent memory

(71) Applicant: Continental Autonomous Mobility Germany GmbH, Ingolstadt (DE)

(72) Inventors: Stefan Hegemann, Wangen im Allgäu (DE); Gerrit Wischer, Münster (DE)

(73) Assignee: Continental Autonomous Mobility Germany GmbH, Ingolstadt (DE)

(21) Appl. No.: 19/243,444

(22) Filed: Jun. 19, 2025

(30) Foreign Application Priority Data
Jun. 24, 2024 (DE) 102024205865

(51) Int. Cl. G07C 5/02; G07C 5/00

(52) U.S. Cl. CPC G07C 5/02; G07C 5/008

(57) ABSTRACT

A method for an autonomously driving vehicle to store environment detection data in a permanent memory, wherein a situation analysis is started when a trigger criterion is fulfilled; the situation analysis carries out an evaluation of data from at least one environment detection sensor with regard to misbehavior directed towards the autonomous vehicle; and depending on the result of the situation analysis, data from at least one environment detection sensor is stored in a permanent memory.

This application claims priority to German Application No. 102024205865.3, filed Jun. 24, 2024, the contents of such application being incorporated by reference herein.

### FIELD OF THE INVENTION

The invention relates to the technical field of autonomously driving vehicles.

### BACKGROUND OF THE INVENTION

Autonomously driving vehicles must master even complex, unknown situations independently. If a situation can no longer be controlled by an autonomous vehicle itself, the vehicle is brought to a safe stop. Other road users could wilfully cause autonomously driving vehicles to come to a stop, as an autonomously driving vehicle will try to prevent accidents under all circumstances.

One area of application for autonomously driving vehicles is robotaxis, which typically transport people over short distances in urban environments or on expansive sites such as university campuses, Olympic sites, factory premises or trade fairs. Another area of application is the long-distance transportation of goods by road using autonomously driving trucks on applicable highways or freeways. The driving behavior of autonomous vehicles differs from manually-operated vehicles because, for example, a greater safety distance is maintained or the vehicle brakes in a situation that is not comprehensible to human road users. This supposedly disruptive behavior could cause resistance to autonomously driving vehicles from other road users. Another reason for aggression towards autonomously driving vehicles could be that jobs are being lost as a result of automation. Opponents of the technology or disgruntled road users could therefore deliberately perform actions which obstruct or even bring an autonomously driving vehicle to a stop, which can in turn pose a risk and/or be an obstruction to other road users. The above-mentioned applications are examples of autonomously driving vehicles, preferably without a driver on board, for which an aspect of the invention is used.

### SUMMARY OF THE INVENTION

The aspect of the present invention is to document deliberate misbehavior towards autonomously driving vehicles. Such misbehavior constitutes behavior that puts traffic at risk, as it causes accidents or a disruption to automated driving operation. However, since an autonomously driving vehicle tries to prevent accidents under all circumstances, the traffic following behind will be put at risk if the autonomously driving vehicle is, for example, prompted to perform emergency braking.

According to an aspect of the invention, a method for an autonomously driving vehicle to store environment detection data in a permanent memory is claimed. It is provided that a situation analysis is started when a trigger criterion is fulfilled. The trigger criterion indicates whether an unforeseen, abrupt driving maneuver is necessary for the autonomously driving vehicle or whether the vehicle is brought to a stop, for example because a road is blocked or the traffic situation is too complex.

In this case, a situation analysis is started. For this purpose, an evaluation of data from at least one environment detection sensor, which was recorded in a period of time before the trigger criterion occurred, for example 1.5 or 10 seconds before, is analyzed. The data is temporarily stored in a non-permanent memory.

The situation analysis evaluates the overall situation and not only the behavior of the autonomously driving vehicle. It evaluates in particular what it was about the object in front of the autonomously driving vehicle to which there was a reaction that led the autonomously driving vehicle to react. The focus here is on the object, which was critical for us at the time, and its surroundings, which could have triggered the reaction of the vehicle driving in front. The situation is also analyzed over a predefined time period, as some reactions may only become clear over time.

The environment detection sensors of the autonomous vehicle are in particular in the form of radar, lidar and/or camera sensors and record data relating to other road users in the environment of the vehicle. This data documents the behavior of the other road users towards the autonomously driving vehicle, and it is analyzed whether there is deliberate misbehavior towards the autonomously driving vehicle, for example cutting in and/or abruptly braking for no apparent reason just in front of the autonomous vehicle. This behavior can be identified, for example, from camera images or on the basis of distance information from a radar or lidar sensor. It can be identified and evaluated by means of artificial intelligence methods, on a classical basis or on the basis of neural networks (CNN, DNN, GAN, LSTM, etc.). In the case described above, the result of the situation analysis would be that there could be deliberate misbehavior. If the vehicle driving in front brakes sharply for a valid reason, for example due to the end of a traffic jam, the result of the situation analysis is that there is no misbehavior. Depending on the result of the situation analysis, namely if there could be deliberate misbehavior of another road user, the data from at least one environment detection sensor is stored in a permanent memory and permanently saved.

In an advantageous configuration of an aspect of the invention, the trigger criterion for a situation analysis is an evasive maneuver by the autonomous vehicle that results in a predefined steering angle being exceeded.

Alternatively, required braking of the autonomous vehicle above a predefined deceleration value, for example with a deceleration above 0.5 g, can trigger the situation analysis. Other suitable criteria include exceeding or falling below a critical value, in particular a time to collision with an object in the surroundings or a blocked route.

A positive configuration of an aspect of the invention provides that a situation analysis is triggered when there is an accumulation of the previously described trigger reasons within a predefined period of time, for example within one minute, even if each individual reason is below the trigger threshold predefined therefor. An accumulation is understood to be at least two or more events within the period of time. A further embodiment can also provide for a chain of certain predefined events, for example two braking interventions within the predefined period of time or first a steering intervention and then a braking intervention.

A further configuration of an aspect of the invention provides that, in addition to the data from the at least one environment detection sensor, one or more of the following items of data of the autonomous vehicle is/are stored in a permanent memory: speed, brake status, engine speed, activity of ABS and stability control and/or steering angle. This additional data documents the measures that the autonomous vehicle used, or had to use, to react to the triggering situation. This can also be regarded as a measure of the risk posed to the autonomously driving vehicle or posed to other road users by the autonomously driving vehicle.

A non-permanent memory is preferably provided to hold the data for a predefined duration such that it can be used for a situation analysis after the trigger criterion has been fulfilled and/or, depending on the result of the situation analysis, it can be stored in a permanent memory. The non-permanent data memory is in particular in the form of a circular buffer that stores the data for a predefined time period. Ideally, the predefined time period takes a value between 30 seconds and 2 minutes. It should also be possible to assess a plurality of incidents in quick succession.

A positive development of an aspect of the invention provides that the data stored in the permanent memory is transmitted, for example by radio transmission, to an operator of the autonomous vehicle and/or to a collection point for misbehavior towards autonomous vehicles. Once the data has been successfully transmitted, it can be deleted from the permanent memory arranged in the autonomous vehicle.

In a further embodiment of the invention, the transmitted data is relayed by the operator of the autonomous vehicle to the competent traffic authority and/or to a collection point. Ideally, the data is verified again beforehand in an automated manner or by a person. In an advantageous configuration of an aspect of the invention, the data transmitted by the autonomous vehicle is used, regardless of whether or not it is relayed to the authorities, to improve the functionality of the autonomously driving vehicle or of other autonomously driving vehicles. The use of the transmitted information with the additionally added information (label) is, in particular, to a positive or negative result of the verification, which can be carried out in an automated manner or by a person, as described above.

A control device in the autonomously driving vehicle for carrying out the method described above is claimed. The control device (or also electronic control unit, ECU, or assisted & automated driving control unit, ADCU) can expediently comprise a computer, processor, controller, computing device or the like in order to carry out the method according to an aspect of the invention. A computer program with program code or also neural networks (CNN, DNN, GANs, etc.) can be provided for carrying out the method according to an aspect of the invention, with the method being carried out, for example, when the computer program is executed on a computer or other programmable computing device known from the prior art. The computer can be in the form of a control device or part of the control device (for example an IC (integrated circuit) module, SoC (system-on-chip) or microcontroller or the like). Furthermore, the method could also be implemented or retrospectively installed in existing systems as a computer-implemented method. In an advantageous manner, a computer-readable storage medium can be provided for this purpose, on which the algorithm or the program or the method is stored. In the context of an aspect of the invention, the term “computer-implemented method” describes in particular the sequence planning or the method steps or the procedure which is implemented or carried out on the basis of the computer, with the computer being able to process the applicable data by means of programmable computation rules.

### BRIEF DESCRIPTION OF THE DRAWINGS

FIG. 1 illustrates the sequence of the method according to an aspect of the invention;

FIG. 2 schematically shows a control unit according to an aspect of the invention; and

FIG. 3 illustrates an arrangement for data storage according to an aspect of the invention.

### DETAILED DESCRIPTION OF EXEMPLARY EMBODIMENTS

An aspect of the invention will be explained in more detail below on the basis of drawings and exemplary embodiments:

### Exemplary Embodiment 1

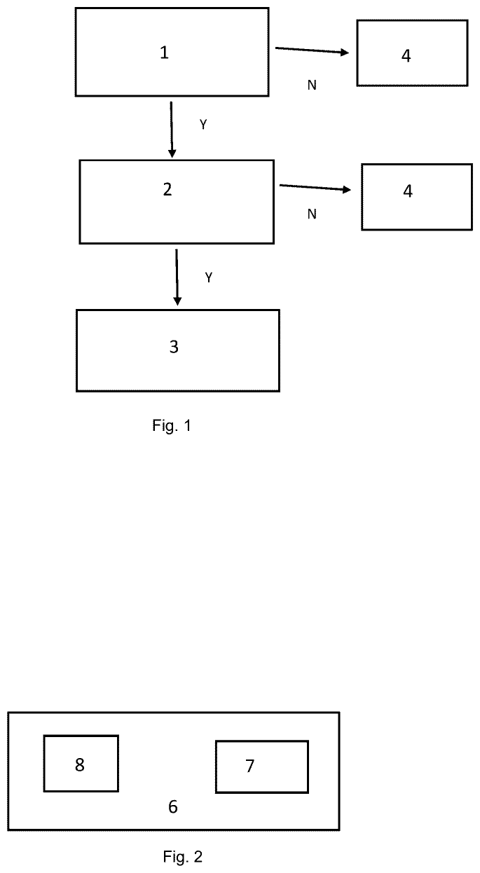

FIG. 1 illustrates the sequence of the method according to an aspect of the invention. A first method step 1 checks whether the trigger criterion is fulfilled. In this exemplary embodiment, the trigger criterion is fulfilled by the autonomously driving vehicle braking sharply with a deceleration above a predefined threshold value and shortly afterwards falling below the threshold value for a time to collision with the vehicle driving in front. An autonomously driving vehicle will always try to prevent accident/death for road users and will thus trigger emergency braking in the lane.

The trigger criterion is fulfilled (Y) and the method provides a situation analysis 2 as the next step. This checks whether the braking was triggered by misbehavior of another road user. The environment data recorded with the radar and camera environment sensors prior to triggering shows another vehicle cutting in sharply in front of the autonomously driving vehicle without maintaining a sufficient safety distance. In addition, the car that cut in brakes again briefly after cutting in, such that the safety distance is further reduced.

An assessment of these two incidents leads to the evaluation Y, i.e. there could be deliberate misbehavior and in this case the method provides for permanent storage 3 of the environment data.

### Exemplary Embodiment 2

In an alternative exemplary embodiment, the trigger criterion is fulfilled in a first method step 1 by the autonomously driving vehicle braking sharply with a deceleration above a predefined threshold value.

The trigger criterion is therefore fulfilled Y and the method provides a situation analysis 2 as the next step. This checks whether the braking was triggered by misbehavior of another road user. The environment data recorded with the radar and camera environment sensors prior to triggering shows that the vehicle driving in front is approaching the end of a traffic jam and must therefore brake sharply to avoid a collision.

An assessment of this incident leads to the evaluation N, i.e. there is no deliberate misbehavior and the method ends in step 4 without the permanent storage of the environment data.

### Exemplary Embodiment 3

In a further exemplary embodiment, the trigger criterion is fulfilled in a first method step 1 by the autonomously driving vehicle coming to a stop due to a complex traffic situation and a situation analysis is carried out. An analysis of the environment data, in particular recorded with radar, lidar and camera sensors, shows that misleading images of roadworks markings or images similar to roadworks markings have been applied to vehicles in the surroundings, making it impossible for the autonomously driving vehicle to reliably identify its own traffic lane, such that it is brought to a stop. The situation analysis evaluates the situation as Y, i.e. yes, there could be deliberate misbehavior, and the method provides for permanent storage 3 of the environment data in this case.

FIG. 2 schematically shows a control unit 6 with a processor 7 and a storage medium 8. The method described above is stored on the storage medium and can be carried out by the processor.

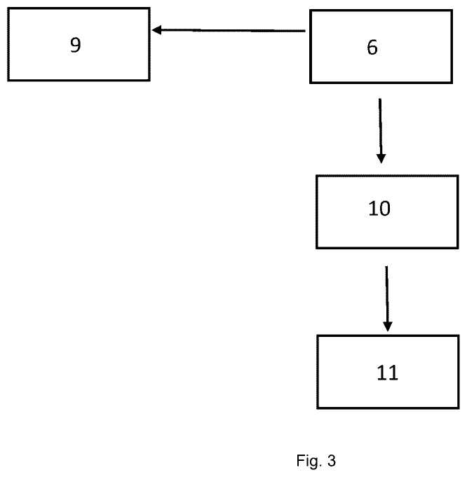

FIG. 3 shows an arrangement for data storage by way of example. In this exemplary embodiment, the permanent memory 9 is arranged in the so-called black box of the vehicle. For this purpose, a further storage medium has simply been placed in the black box. The method according to an aspect of the invention is stored on a storage medium 8 in the control unit 6. The control unit 6 has a processor 7 for carrying out the method. The control unit 6 is connected to the memory in the black box 9 via a communication interface such that data can be stored on the memory 9. In addition, the control unit 6 is connected to a communication unit for wireless transmission of the data to be permanently stored. The data can thus be transferred to the operator, in particular to an electronic memory 10 of the fleet operator. A further step 11 provides for the data to be verified with regard to misbehavior by a human assessor.

In particular, situations that are not identified or interpreted by the sensors because they are too minor are analyzed, such as reflex braking after a bird strike or a pothole that is critical for a car but irrelevant for an autonomously driving truck. If the assessor comes to the conclusion that there is deliberate misbehavior of another road user, the data and, if necessary, a report are relayed to the authorities. Once the process has been completed by the operator, a signal is output to the control unit 6 via a wireless communication device, which control unit then deletes the data from the permanent memory 9 in the vehicle.

### LIST OF REFERENCE NUMERALS

1 Trigger criterion fulfilled?
2 Situation analysis identifies misbehavior?
3 Storage of data in permanent memory
4 End of the method
6 Control unit
7 Processor
8 Storage medium
9 Black box with permanent memory for data relating to misbehavior
10 Data memory operator
11 Verification of the suspected misbehavior

1. A method for an autonomously driving vehicle to store environment detection data in a permanent memory, wherein
a situation analysis is started when a trigger criterion is fulfilled,
the situation analysis carries out an evaluation of data from at least one environment detection sensor with regard to misbehavior directed towards the autonomous vehicle, and
depending on the result of the situation analysis, data from at least one environment detection sensor is stored in a permanent memory.

2. The method as claimed in claim 1, wherein the trigger criterion is evasive maneuvering and/or a braking operation above a predefined deceleration value and/or exceeding a critical value for a collision and/or blocking the route.

3. The method as claimed in claim 1, wherein a trigger criterion is repeated evasive maneuvering and/or an emergency braking operation and/or a braking operation above a predefined deceleration value and/or exceeding a critical value for a collision within a predefined duration.

4. The method as claimed in claim 1, wherein, in addition to the data from the at least one environment detection sensor, one or more of the following items of data of the autonomous vehicle is/are stored in a permanent memory: speed, brake status, engine speed, activity of ABS and stability control and/or steering angle.

5. The method as claimed in claim 1, wherein data is held in a non-permanent memory for a predefined duration and is stored in a permanent memory only after the trigger criterion has been fulfilled and the situation analyzed.

6. The method as claimed in claim 1, wherein data stored in the permanent memory is transmitted by radio transmission to an operator.

7. A non-transitory computer-readable storage medium comprising instructions which are executable by at least one processor/computer and which, when executed by a computer, cause the computer to carry out the method as claimed in claim 1.

8. A non-transitory computer program comprising instructions which, when the computer program is executed by a computer, cause the computer to carry out the method as claimed in claim 1.

9. An autonomously driving vehicle with an electronic control unit comprising a processor and a permanent memory on which a method as claimed in claim 1 is stored.
